(19) United States
(12) Patent Application Publication
(10) Pub. No.: US 2016/0010199 A1
(43) Pub. Date: Jan. 14, 2016

(54) PROCESSES AND SYSTEMS FOR DEPOSITING COATING SYSTEMS, AND COMPONENTS COATED THEREWITH

(71) Applicant: General Electric Company, (US)

(72) Inventors: Matthew Alan Rodgers, Cincinnati, OH (US); John Edmund Nerz, Hebron, KY (US); Robert Glynn Miner, Cincinnati, OH (US)

(73) Assignee: GENERAL ELECTRIC COMPANY, Schenectady, NY (US)

(21) Appl. No.: 13/744,856

(22) Filed: Jan. 18, 2013

Related U.S. Application Data
(60) Provisional application No. 61/670,171, filed on Jul. 11, 2012.

(51) Int. Cl. C23C 4/12; B05B 15/04; B05B 7/16; C23C 4/08; C23C 4/10

(52) U.S. Cl. CPC C23C 4/12; C23C 4/08; C23C 4/105; B05B 7/1606; B05B 15/0443

(57) ABSTRACT

Processes and systems for forming a coating system on a component. The process of forming the coating system on the component includes placing an apparatus in a location that promotes coating particles in flight to be redirected towards a surface on the component. The surface is obstructed by portions of the component limiting line-of-sight from a source of the coating particles to the surface. The coating particles are then deposited onto the surface of the component. The coating particles initially travel in a direction of initial particle travel and are redirected by the apparatus towards the surface on the component at a direction of final particle travel relative to the surface. The line-of-site from the source of the coating particles is at an angle of less than 30 degrees relative to the surface of the component and the direction of final particle travel is at an angle of 30 degrees or more relative to the surface of the component.

### CROSS REFERENCE TO RELATED APPLICATIONS

This application claims the benefit of U.S. Provisional Application No. 61/670,171, filed Jul. 11, 2012, the contents of which are incorporated herein by reference.

### STATEMENT REGARDING FEDERALLY SPONSORED RESEARCH

This invention was made with government support under Contract No. N00019-04-C-0093 awarded by U.S. Government (Department of Defense, Air Force). The Government has certain rights in the invention.

### BACKGROUND OF THE INVENTION

The present invention generally relates to coating systems and processes for their deposition. More particularly, this invention relates to a process and system for forming a coating on a component by redirecting coating particles during a spray deposition process.

Various coating processes have been developed to deposit metallic and ceramic coating materials capable of surviving and remaining adherent in chemically and thermally hostile environments such as those of a gas turbine. Examples include thermal spraying, physical vapor deposition (PVD), and chemical vapor deposition (CVD). Thermal spraying processes are line-of-sight processes. In the thermal spray process a stream of plasma containing metallic or ceramic particles exits a spray nozzle (“gun”) at a high velocity and high temperature in the direction of an article on whose surface the particles are deposited. The intention of the coating is to protect the article with a coating that shows complete coverage over the surface and has a consistent microstructure. Typically, the stream of particles travels line-of-sight to deposit on the surface of the article.

The line-of-sight accessibility of articles can be a major limitation in the design of gas turbine engine components. To illustrate, FIG. 1 represents ceramic or metallic coating particles 16 being deposited on seal teeth 12 of a gas turbine component 10. The coating particles 16 are schematically represented as being deposited on the seal teeth 12 by a nozzle 14 of a thermal spraying device. Due to the limited line-of-sight of the nozzle 14 to the component 10, the coating particles 16 may be unable to uniformly coat the seal teeth 12. A seal tooth 12 that has been coated by a process similar to what is represented in FIG. 1 is shown in FIG. 2. The resulting coating is not uniform, and shows areas on the surface of the seal tooth 12 with almost no coating. Generally, with thermal spray processes line-of-sight access to a surface to be coated must be at an angle of at least 30 degrees relative to the surface to obtain a coating with conforming microstructure along with complete coverage over the surface. Anything less than a 30 degrees access angle will likely result in a coating structure that is nonconforming to specifications and has intermittent coating coverage, such as shown in FIG. 2.

Even coatings sprayed at an access angle of approximately 30 degrees may have marginally acceptable coatings requiring significant amounts of rework. Further, with restricted line-of-sight accessibility, the robustness of the coating quality is reduced and may not be repeatable. Both of these issues introduce a significant amount of variation into the thermal spray process.

Presently, in instances where the direct-line-of-sight access is restricted to less than 30 degrees, engineers must resort to other processes to deposit the coating or must design around a nonconforming coating with intermittent coverage. Other potential processes include plating the surface of the component 10. In some instances, depending on the risk, the surface of a component 10 may be uncoated. Historically, components have also been designed to account for line-of-sight limitations of coating deposition processes to achieve increased spray access angles, though potentially at the expense of weight or performance.

Accordingly, there is a need for a spray process capable of depositing a ceramic or metallic coating on a component in situations where the line-of-site access angle to the surface to be coated is less than 30 degrees.

### BRIEF DESCRIPTION OF THE INVENTION

The present invention provides processes and systems for forming a coating on a component when the line-of-site access angle to a surface of the component to be coated is less than 30 degrees.

According to a first aspect of the invention, a process of forming a coating system on a component includes placing an apparatus in a location that promotes coating particles in flight to be redirected towards a surface on the component. The surface is obstructed by portions of the component limiting line-of-sight from a source of the coating particles to the surface. The coating particles are then deposited onto the surface of the component. The coating particles initially travel in a direction of initial particle travel and are redirected by the apparatus towards the surface on the component at a direction of final particle travel relative to the surface. The direction of initial particle travel forms an angle relative the surface on the component that is different than the angle formed by the direction of final particle travel relative to the surface.

According to a second aspect of the invention, a system includes means for depositing coating particles onto a surface of a component. The surface is obstructed by portions of the component limiting line-of-sight from a source of the coating particles to the surface. The depositing means causes the coating particles to travel in a direction of initial particle travel relative to the surface of the component. The system includes means for causing the coating particles to be redirected in flight towards the surface on the component from the direction of initial particle travel to a direction of final particle travel relative to the surface. The direction of initial particle travel forms an angle relative the surface on the component that is different than the angle formed by the direction of final particle travel relative to the surface.

A technical effect of the invention is the ability to spray coat a surface in the event that the line-of-site access angle to the surface is less than 30 degrees. In particular, it is believed that by using an apparatus to redirect the coating particles towards the surface on the component to be coated, a uniform coating may be deposited on the surface despite the low line-of-site access angle.

Other aspects and advantages of this invention will be better appreciated from the following detailed description.

### BRIEF DESCRIPTION OF THE DRAWINGS

FIG. 1 represents a conventional thermal spraying process wherein coating particles are being deposited onto seal teeth of a component.

FIG. 2 shows a micrograph of a seal tooth formed on a component coated by a conventional thermal spraying process similar to that shown in FIG. 1.

FIGS. 3 and 4 represent a thermal spraying process wherein coating particles are redirected with ramps prior to being deposited onto seal teeth of a component in accordance with an embodiment of the present invention.

FIG. 5 shows a micrograph of a seal tooth of a component on which a coating has been deposited by a thermal spraying process in accordance with an embodiment of the present invention.

FIG. 6 represents a thermal spraying process wherein coating particles are redirected with ramps secured to the thermal spraying device prior to being deposited onto seal teeth of a component in accordance with an embodiment of the present invention.

### DETAILED DESCRIPTION OF THE INVENTION

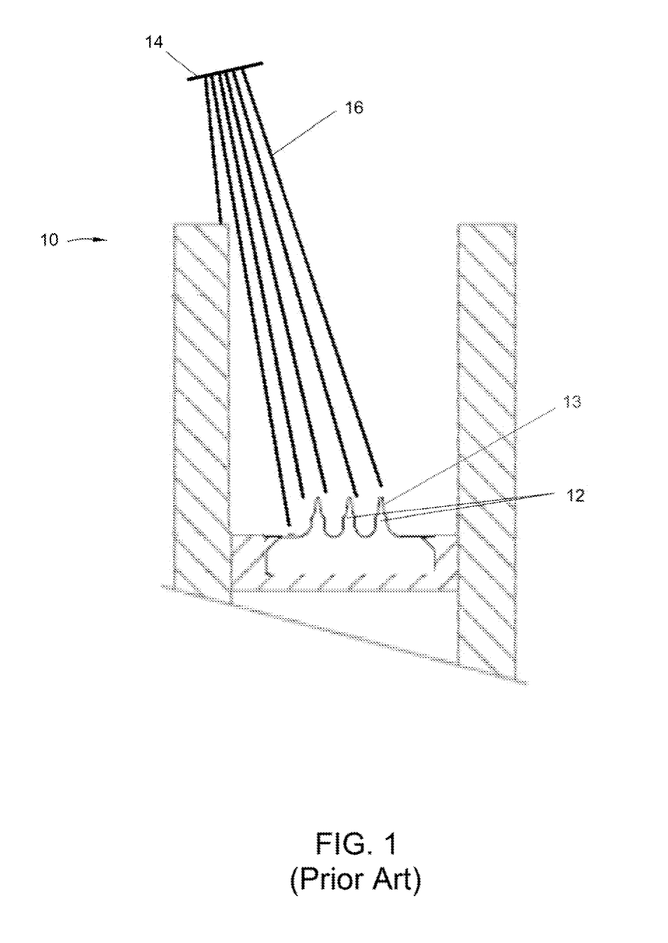

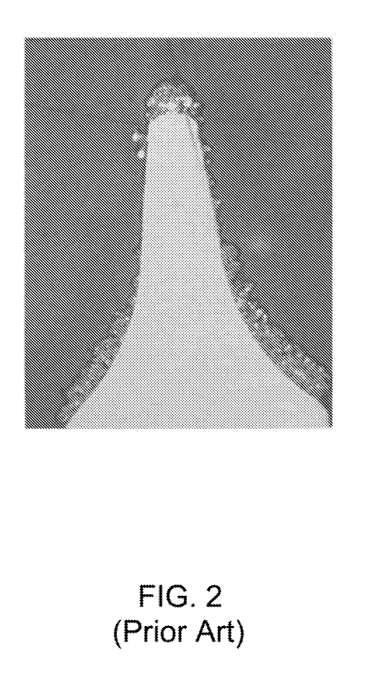

The present invention is generally applicable to components that may be coated by a spraying process wherein the design of the components provides a line-of-site access angle to the surface to be coated of less than 30 degrees. Notable examples of such components include gas turbine engine components, such as the gas turbine component 10 of FIG. 1 comprising seal teeth 12. Although the invention will be described hereinafter in reference to the gas turbine component 10, it will be appreciated that this is exemplary and that the invention has application to other components. Coatings formed by the invention may be comprised of any suitable material such as, but not limited to, ceramics, metallics, cermets, and carbides.

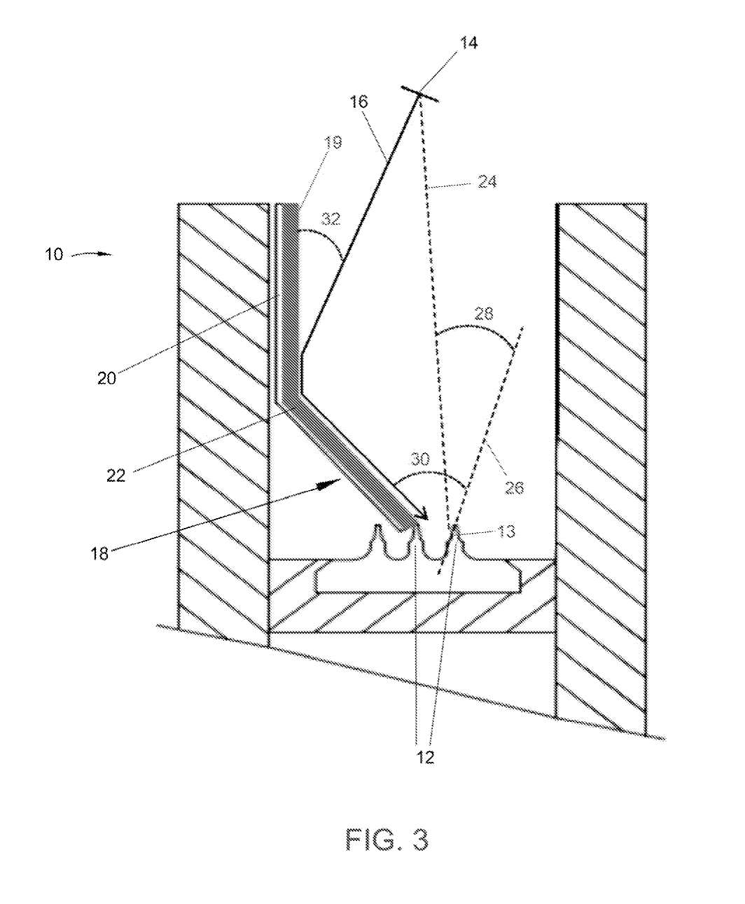

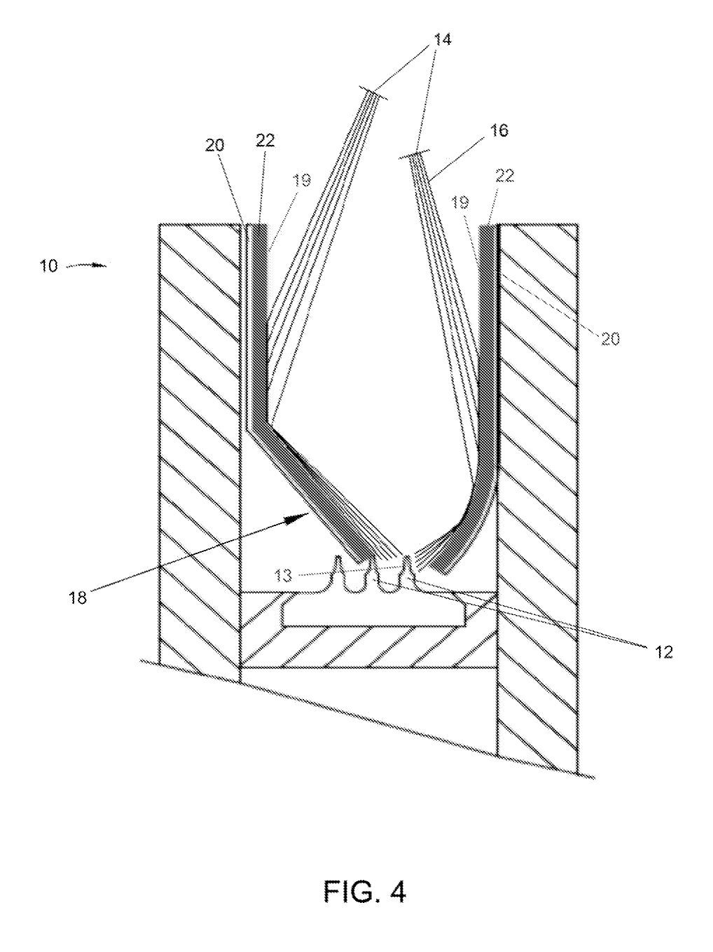

FIGS. 3 and 4 represent a component 10 of the type shown in FIG. 1 undergoing a thermal spray process in accordance with an embodiment of the present invention. As such, FIGS. 3 and 4 represent a seal tooth 12 of the component 10 as being thermal sprayed with coating particles 16, for example, ceramic or metallic particles deposited on surfaces 13 of the tooth 12. FIGS. 3 and 4 further represent one or more ramps 18 positioned to redirect the coating particles 16 after they have been propelled from one or more nozzles 14 to impinge the ramps 18 and then travel across surfaces of the ramps 18 towards the surfaces 13 of the seal tooth 12. From FIG. 4, it should be appreciated that one or more ramps 18 can be used in combination with one or more nozzles 14 to optimize the trajectory or trajectories of the coating particles 16 and/or enable simultaneous coating of one or more surfaces of an article, including oppositely-disposed surfaces of the article.

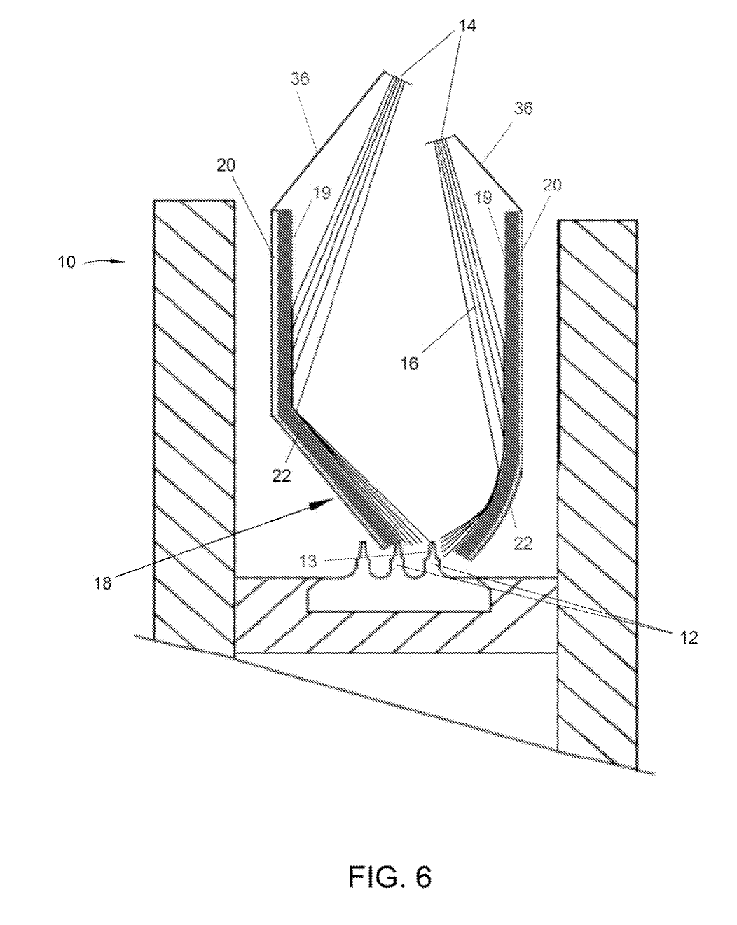

After leaving one of the nozzles 14 at an initial direction of particle travel relative to a targeted surface of the tooth 12, the coating particles 16 impact and then slide along a surface 19 of a corresponding one of the ramps 18, enabling the coating particles 16 to be re-vectored at a more favorable access angle 30 (that is, at least 30 degrees) for line-of-sight deposition onto the targeted surface 13 of the tooth 12. The ramps 18 can be mounted directly to the component 10, as represented in FIGS. 3 and 4, or mounted to the spray device or the nozzle 14 itself. FIG. 6 represents the ramps 18 as being secured to the spray device by connectors 36. The ramps 18 are preferably adapted to be located and secured to the component 10 by aligning and attaching the ramps 18 on well-defined features of the component 10, for example, bolt holes, rabbets, mounting flanges, or under blade platforms, allowing for uniformity and consistency in the microstructure of the deposited coating and ease of installation. The ramps 18 may further provide masking of other features of the component 10 where a coating is undesirable. When the coating particles 16 arrive at the surface 13 of the seal tooth 12, the coating particles 16 directly impinge the surface 13 while traveling in a final direction of particle travel at an access angle 30 of at least 30 degrees relative to the surface 13, though the actual line-of-sight angle 28 between the nozzle 14 and surface 13 being coated may have been less than 30 degrees. In order for the coating particles 16 to be effectively re-vectored, the initial direction of particle travel leaving the nozzle 14 should form an impact angle 32 of not less than 10 degrees with the surface 19 of the ramp 18. Preferably, the impact angle 32 is between about 10 degrees and about 20 degrees, and most preferably, between about 10 degrees and about 15 degrees. It will be appreciated that due to the spray pattern of the trajectory of the coating particles 16, the terms “direction” and “angle” are in reference to a “nominal” direction of particle travel, e.g., the central axis of the flow pattern. Preferably, the access angle 30 is as close to 90 degrees as possible in order to provide a suitable coating on the surface 13.

Each ramp 18 defines the surface 19 whose shape or contour serves to redirect the coating particles 16 towards a surface of the tooth 12 to be coated. FIGS. 3 and 4 represent each ramp 18 as comprising a substrate 20, and further represent each substrate 20 as preferably having a surface material or coating 22 that defines its respective ramp surface 19. The coating 22 is preferably adapted to promote sliding of the coating particles 16 as they travel across the surface 19 of the ramp 18 as well as survive the temperature of the plasma spray process. For this purpose, the coating 22 may be, for example, an elastomeric (rubberized) or ceramic material applied to the substrate 20. Although the surface 19 of the ramps 18 are represented as being flat, it is foreseeable that the surface 19 could be curved or cupped, that is, higher on the edges and lower in the center of the ramp 18, to promote coating particles 16 to remain on the ramp 18 during redirection. In addition, the ramps 18 could be a fully contained contoured tube-like structure through which the coating particles 16 travel towards the surface 13 of the tooth 12. Any number of ramps 18 may be used in the spraying process and the surfaces 19 of the ramps 18 may have any shape or size suitable for redirecting the coating particles 16 in a desired manner. Other parameters such as the distance between the ramp 18 and the surface 13 depend on the particular component to be coated.

Further optimization of the process can be achieved with modifications to conventional spray parameters for applications where the line-of-sight is at least 30 degrees. Other modifications may include alternative types of nozzles 14, the use of coating particles 16 having a particular size distribution range, alternative types of materials for the coatings 22 on the ramps 18, and the amount of contact surface 19 of the ramp 18. Actual modifications to conventional spray parameters depend on the shape, size, and line-of-sight access angle 28 to the particular surface 13 to be coated in any given application. All such optimizations and modifications are within the scope of the invention.

In investigations leading to the present invention, seal teeth 12 were thermal spray coated first with a metallic (NiAl) bond coat and then with a ceramic (alumina; Al₂O₃) top coat. Over one hundred trials were performed in order to investigate this process. Several parameters were investigated, such as the particle size and composition of the coating particles 16, gun type, nozzle type, gases used, shape and size of ramps 18, number of ramps 18, etc. A suitable particle size and distribution were found to be between about 400 to about 200 mesh (about 35 to about 75 micrometers) with no more than about five percent of the particles being larger than 200 mesh (about 75 micrometers) and no more than about fifteen percent of the particles being smaller than 400 mesh (about 35 micrometers).

A particularly suitable embodiment was determined to be essentially the configuration and process schematically represented in FIGS. 3 and 4. As represented, a first ramp 18 has a lower portion whose surface 19 is flat (planar) and angled towards a surface 13 of a seal tooth 12 to be coated. FIG. 4 depicts the use of a second ramp 18 whose surface 19 is arcuate and curved towards the opposite surface 13 of the same seal tooth 12. The planar shape of the first ramp 18 was found to be particularly effective at coating a surface 13 of a seal tooth 12 that is facing an adjacent seal tooth 12. The ramp 18 was found to fully coat the surface 13 of the seal tooth 12 without interference from the adjacent surface. The curved shape of the second ramp 18 was found to be more effective at coating a surface 13 of a seal tooth 12 that was immediately facing an adjacent surface of the component 10. The additional unoccupied area (access area) around the surface 13 of the seal tooth 12 allowed for the use of the second ramp 18 that provided a more even coating. Consequently, it will be appreciated that, as an alternative to the represented arrangement, two planar ramps 18 or two curved ramps 18 can be used depending on the available access area and adjacent objects in the vicinity of the surface 13 to be coated. In order to provide adequate redirection of the coating particles 16 along the surface 19 of the ramp 18, the coating particles 16 preferably travel a distance of at least about 0.5 inch (about 12.5 millimeters) along the surface 19 of the ramp 18 prior to impacting the surface 13.

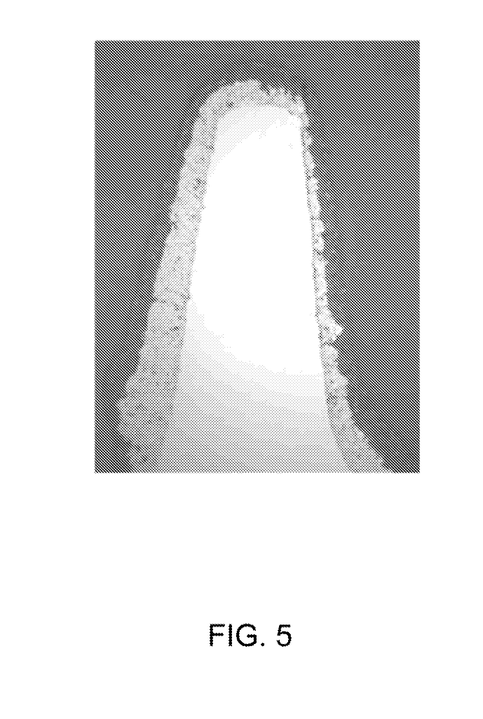

In FIG. 4, each of the seal teeth 12 to be coated is individually sprayed utilizing the two ramps 18 as shown so that the oppositely disposed surfaces 13 of an individual tooth 12 are simultaneously coated. Although FIG. 4 represents only one seal tooth 12 being coated at any given time, it is foreseeable that the ramps 18 could be arranged to allow multiple seal teeth 12 to be coated at once. For example, multiple ramps 18 could be attached wherein each set of ramps 18 are located in a position to coat a separate seal tooth 12. A coated seal tooth 12 resulting from a trial performed by this process is shown in FIG. 5. Metallographic evaluation of the seal tooth 12 confirmed complete coverage with a uniform coating microstructure. To date, this process has been successfully applied to rotor abrasive seal teeth for turbofan engines, though the technology is believed to be applicable to substantially any thermal spray coating.

While the invention has been described in terms of specific embodiments, it is apparent that other forms could be adopted by one skilled in the art. For example, the physical configuration of the ramps 18 could differ from that shown, and materials and processes other than those noted could be used. Therefore, the scope of the invention is to be limited only by the following claims.

1. A process of forming a coating system on a component, the process comprising:
placing an apparatus in a location that promotes coating particles in flight to be redirected towards a surface on the component, wherein the surface is obstructed by portions of the component limiting line-of-sight from a source of the coating particles to the surface; and then
depositing the coating particles onto the surface of the component, wherein the coating particles initially travel in a direction of initial particle travel and are redirected by the apparatus towards the surface on the component at a direction of final particle travel relative to the surface, wherein the direction of initial particle travel forms an angle relative the surface on the component that is different than the angle formed by the direction of final particle travel relative to the surface.

2. The process of claim 1, wherein the line-of-site from the source of the coating particles is at an angle of less than 30 degrees relative to the surface of the component and the direction of final particle travel is at an angle of 30 degrees or more relative to the surface of the component.

3. The process of claim 1, wherein the depositing step is performed by a thermal spraying process.

4. The process of claim 1, wherein oppositely disposed surfaces of the component are simultaneously coated.

5. The process of claim 1, wherein a surface of the apparatus impacted by the coating particles has a flat or curved shape.

6. The process of claim 1, wherein the apparatus comprises first and second ramps each comprising a surface that is impacted by the coating particles and redirects the coating particles towards the surface on the component, wherein the surfaces of the first and second ramps oppose each other.

7. The process of claim 6, wherein the surfaces of the first and second ramps have different shapes.

8. The process of claim 6, wherein the surface of the first ramp has a flat shape and the second ramp has a curved shape.

9. The component having a coating system formed by the process of claim 1.

10. The process of claim 1, wherein the component is a component of a turbine engine.

11. A system comprising:
means for depositing coating particles onto a surface of a component, wherein the surface is obstructed by portions of the component limiting line-of-sight from a source of the coating particles to the surface, the depositing means causing the coating particles to travel in a direction of initial particle travel relative to the surface of the component; and
means for redirecting the coating particles in flight towards the surface on the component from the direction of initial particle travel to a direction of final particle travel relative to the surface, wherein the direction of initial particle travel forms an angle relative to the surface on the component that is different than the angle formed by the direction of final particle travel relative to the surface.

12. The process of claim 11, wherein the line-of-site from the source of the coating particles is at an angle of less than 30 degrees relative to the surface of the component and the direction of final particle travel is at an angle of 30 degrees or more relative to the surface of the component.

13. The system of claim 11, wherein the redirecting means comprises a surface having a flat or curved shape that is impacted by the coating particles.

14. The system of claim 11, wherein the redirecting means is adapted to simultaneously coat the surface and a second oppositely disposed surface of the component.

15. The system of claim 11, wherein the redirecting means comprises first and second ramps each comprising a surface impacted by the coating particles, wherein the surfaces of the first and second ramps oppose each other.

16. The system of claim 15, wherein the surfaces of the first and second ramps have different shapes.

17. The system of claim 15, wherein the surface of the first ramp has a flat shape and the second ramp has a curved shape.

18. The system of claim 11, wherein the depositing means comprises a thermal spraying device having a nozzle from which the coating particles are propelled.

19. The system of claim 18, wherein the redirecting means is secured to the thermal spraying device.

20. A process of coating the surface of the component with the system of claim 11, the method comprising:
placing the redirecting means in a location that promotes coating particles to be redirected towards the surface on the component; and then
depositing the coating particles onto the surface of the component, wherein the direction of final particle travel is at an angle of 30° or more to the surface.
